(19) United States
(12) Patent Application Publication
(10) Pub. No.: US 2025/0170947 A1
(43) Pub. Date: May 29, 2025

(54) COW - BUMPER EXTENDER

(71) Applicant: DISH Wireless L.L.C., Littleton, CO (US)

(72) Inventors: Bryan Lee Bren, Highlands Ranch, CO (US); James Richard Sanders, JR., Suwannee, FL (US); Erik Wayne Madson, Englewood, CO (US); Merwin Dee Wilder, Calhan, CO (US)

(21) Appl. No.: 18/520,176

(22) Filed: Nov. 27, 2023

(51) Int. Cl. B60P 7/08; B60R 19/24

(52) U.S. Cl. CPC B60P 7/0807; B60P 7/0823; B60R 19/24

(57) ABSTRACT

A removable extender for a vehicle includes a first slat having a first mounting bracket disposed at a distal end and a second slat having a second mounting bracket disposed at a distal end. The second slat is spaced apart and substantially parallel to the first slat in an assembled configuration. The removable extender includes a third slat positioned perpendicularly to the first slat and the second slat. The third slat is assembled to the first slat and the second slat using a first mating feature and a second mating feature. At least one strap is included for wrapping around an overhanging article on a vehicle. The at least one strap operably couples a first end region and a second end region of the third slat. The removable extender includes a tensioning device located along the at least one strap between the first end region and the second end region.

### BACKGROUND OF THE INVENTION

Various states have laws regulating oversize and overweight loads on vehicles traveling along highways and roads. Specifically, many laws govern how far a load is permitted to overhang from a vehicle for the safety of others on the road. When transporting a load that is considered oversize, overweight, or overhangs beyond the prescribed limit, shipping permits may need to be acquired. Shipping permits may take considerable time and money to apply for and receive from the appropriate entity.

### BRIEF SUMMARY OF THE INVENTION

According to various embodiments described herein a removable extender is provided that extends the length of a vehicle carrying an overhanging article.

According to one embodiment, a removable extender for a vehicle includes a first slat having a first mounting bracket disposed at a distal end and a second slat having a second mounting bracket disposed at a distal end. The second slat is spaced apart and substantially parallel to the first slat in an assembled configuration. The removable extender includes a third slat, in the assembled configuration, positioned perpendicularly to the first slat and the second slat. The third slat is assembled to the first slat and the second slat using a first mating feature and a second mating feature. At least one strap is included for wrapping around an overhanging article on a vehicle. The at least one strap operably couples a first end region and a second end region of the third slat. The removable extender includes a tensioning device located along the at least one strap between the first end region and the second end region for adjusting an overall length of the at least one strap.

The removable extender may include various optional embodiments. The removable extender may include a distal strap and a second tensioning device located along the distal strap. The distal strap may tension the distal end of the first slat and the distal end of the second slat in the assembled configuration. The first mounting bracket and the second mounting bracket may be operable to secure the first slat and the second slat to the vehicle. The removable extender may include one or more taillights at least partially disposed within the third slat and wiring for providing power to the one or more taillights. The wiring may include a four-pin electrical connector. The first mounting bracket and the second mounting bracket may be pin lock brackets. The removable extender may include one or more reflectors disposed on the third slat. The removable extender may extend beyond a distal end of the vehicle less than or equal to 96 inches. A distal end of the overhanging may article extend beyond the third slat in the assembled configuration less than or equal to 10 inches. A length of the third slat may be less than or equal to a width of the vehicle. The at least one strap may be removably coupled to the first end region and the second end region using one or more carabiners. The first slat may be slidable within the first mounting bracket and the first mating feature, and the second slat is slidable within the second mounting bracket and the second mating feature. The first slat may be integrally formed with the first mounting bracket and the second slat is integrally formed with the second mounting bracket.

According to another embodiment, a removable extender for a vehicle includes an extension component including a first mounting bracket operable to slide along and engage a first track of a vehicle, a second mounting bracket operable to along and engage a second track of the vehicle, and a bumper portion including a first end region and a second end region. The removable extender includes at least one strap for wrapping around an overhanging article on the vehicle. The at least one strap operably couples the first end region and the second end region of the bumper portion.

The removable extender may include various optional embodiments. The first mounting bracket may include a first linear rail corresponding to the first track and the second mounting bracket may include a second linear rail corresponding to the second track. The extension component may be an integrally formed frame. The extension component may be an assembled structure of removably couplable slats. The first mounting bracket and the second mounting bracket may be pin lock brackets. The removable extender may include one or more taillights at least partially disposed within the bumper portion and wiring for providing power to the one or more taillights. The removable extender may include a tensioning device located along the at least one strap between the first end region and the second end region for adjusting an overall length of the at least one strap.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a vehicle having an article overhanging a distalmost end of the vehicle and a removable extender, in accordance with one embodiment of the present disclosure.

FIG. 2A illustrates an assembled removable extender, in accordance with one embodiment of the present disclosure.

FIG. 2B illustrates a disassembled removable extender, in accordance with one embodiment of the present disclosure.

### DETAILED DESCRIPTION OF THE INVENTION

The present disclosure generally relates to a removable extender and in particular to a removable extender that extends the length of a vehicle carrying an overhanging article.

The Department of Transportation (DOT) and states have rules guiding the transportation of loads that hang out of a truck to keep the roads safe for everyone. Hauling overhanging (e.g., oversized) cargo poses dangers to the vehicle hauling the load and to other road users. Various states have a permitting system for ensuring overhanging cargo is properly marked and safely secured. For example, some states require a vehicle having any load overhanging the bumper of the vehicle by a predetermined amount to obtain a permit. The permitting process may be particularly time consuming and expensive. Accordingly, there is a need in the art for extending the bumper of the vehicle such that a permit is not required in all instances. In particular, as would be appreciated by one having ordinary skill in the art, a bumper extender would reduce the length of the cargo that extends beyond the ‘bumper’ of the vehicle and may reduce the length of the cargo such that a permit is not required.

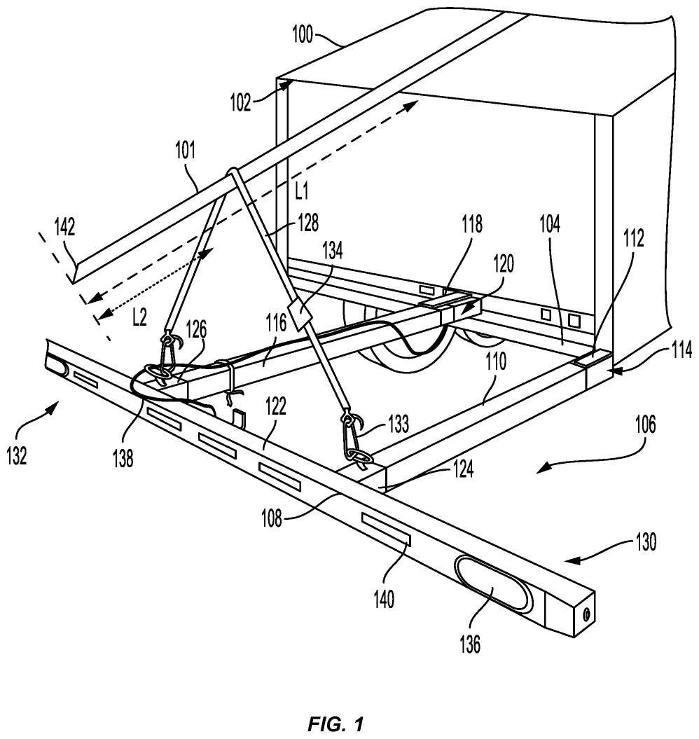

FIG. 1 illustrates a vehicle having an article overhanging a distalmost end of the vehicle and a removable extender. A vehicle 100 transports an article 101 that extends a first distance, L1, from a distalmost edge 102 of the vehicle 100. According to at least some embodiments, vehicle 100 is a truck, tractor, trailer, or any other motorized transportation mechanism suitable for hauling oversized loads. An oversized load may be interchangeably referred to as an overhanging load according to various embodiments of the present disclosure. Various examples of an article 101 that may extend beyond the distalmost edge 102 of the vehicle 100 include lumber, a cell tower, a post, a ladder, a pipe, etc. In various embodiments, the distalmost edge 102 of the vehicle 100 is located at or near the rear of the vehicle (e.g., the end of the vehicle opposite of the driver and passenger seats). In one exemplary embodiment, the distalmost edge 102 of the vehicle 100 is in the same plane and/or L1 is measured from the bumper 104 or the tailgate of the vehicle 100, as shown in FIG. 1.

An oversized load may be any article 101 that extends past the distalmost edge 102 of the vehicle by a predetermined amount. The predetermined amount may be predetermined by state law, federal law, a driver, a company operating the vehicle 100, or the like. In at least some embodiments, the article 101 extends greater than or equal to 60 inches past the distalmost edge 102 of the vehicle 100. For example, L1 may be greater than or equal to 60 inches. As would be appreciated by one having ordinary skill in the art upon reading the present disclosure, L1 may be any length that would require an operator to obtain a permit for an oversized load. An L1 in the foregoing range may require a permit or other licensing mechanism for the vehicle 100 to legally and/or safely travel along roads, highways, freeways, etc.

Embodiments of the present disclosure provide a bumper extender 106 for extending the distalmost edge 102 of the vehicle 100, thereby reducing the length that the article 101 extends beyond the vehicle 100 and eliminating the need for an operator to acquire a permit or the like for transporting the article 101. In particular, the bumper extender 106 creates an extended edge 108 and the article 101 extends length, L2, beyond the extended edge 108. L2 may be less than 59 inches. As would be appreciated by one having ordinary skill in the art upon reading the present disclosure, L2, may be any length that would not require an operator to obtain a permit for transporting the article 101. For example, L2 may vary by state or country and the bumper extender 106 described herein may be configured to accommodate variations in legal requirements according to various jurisdictions.

According to various embodiments, the bumper extender 106 described herein is a removable extender or extension component for the vehicle 100. The bumper extender 106 may be mounted or otherwise coupled to the vehicle 100 as needed, depending on the article 101 being transported and/or the path the vehicle 100 travels. In one exemplary embodiment, the bumper extender 106 is removable and may be disassembled into two or more components for transportation or storage, to be described in further detail below. In other embodiments, the bumper extender 106 is an integrated frame of slats that is removable from the vehicle in a U-shaped configuration. In yet other embodiments, the bumper extender 106 may be permanently or semi-permanently mounted to the vehicle 100. For example, a vehicle 100 may be designated for carrying oversized loads for an extended period of operation. An operator may choose to leave the bumper extender 106 on the vehicle 100 rather than removing and replacing the bumper extender 106 with each article 101.

According to various embodiments, the bumper extender 106 includes a first slat 110 having a first mounting bracket 112 disposed at a distal end 114 of the first slat 110. A slat as used throughout the present disclosure refers to an elongated rigid material which forms the “frame” or perimeter of the bumper extender 106. The slats may comprise metal such as steel, aluminum, wood, other composite materials, or the like. According to various embodiments described herein, the bumper extender 106 and/or the slats are not weight bearing and may include any sufficiently stiff material that is able to withstand the velocity, acceleration, turbulence, etc., associated with being attached to a moving vehicle such as vehicle 100. For example, the bumper extender 106 may extend parallel or substantially parallel to the ground when assembled and mounted to the vehicle 100 without any weight or other downward force applied thereto.

The bumper extender 106 further includes a second slat 116 having a second mounting bracket 118 disposed at a distal end 120 of the second slat 116. As shown in FIG. 1, in the assembled configuration, the second slat 116 is spaced apart and substantially parallel to the first slat 110. The first mounting bracket 112 and the second mounting bracket 118 may be integrated with the first slat 110 and the second slat 116, respectively, according to some embodiments. For example, the first slat 110 may be integrally formed with the first mounting bracket 112 and the second slat 116 may be integrally formed with the second mounting bracket 118. Alternatively, the first mounting bracket 112 and the second mounting bracket 118 are removably coupled to the first slat 110 and the second slat 116, respectively.

According to various embodiments, the first mounting bracket 112 and the second mounting bracket 118 are operable to secure the first slat 110 and the second slat 116 to the vehicle 100. In some embodiments, the first mounting bracket 112 and the second mounting bracket 118 are pin lock brackets. In various embodiments, the first mounting bracket 112 and the second mounting bracket 118 each include a sliding rail (not shown) that mates with a corresponding rail (not shown) on the vehicle 100. For example, the first slat 110 and the second slat 116 may be mounted to the vehicle 100 by aligning the sliding rail and the rail of the vehicle 100 and translating the first slat 110 and the second slat 116 until the first slat 110 and the second slat 116 are stopped by the vehicle and/or pin holes of the first slat 110 and the second slat 116 are aligned with corresponding pin holes on the vehicle 100. Any number or configuration of pin holes may be used. In at least some embodiments, a tight end strap or ratchet strap may be secured to the first mounting bracket 112 and the second mounting bracket 118 in the assembled configuration (e.g., when the bumper extender 106 is mounted to the vehicle 100) to further tension and secure the first slat 110 relative to the second slat 116 and vice versa. As would be appreciated by one having ordinary skill in the art upon reading the present disclosure, any mounting bracket configuration and/or type of mounting bracket may be used to secure the first slat 110 and the second slat 116 to the vehicle 100 and the bumper extender 106 as described herein should not be limited to any particular mounting bracket configuration.

According to various embodiments, the bumper extender 106 further includes a third slat 122 that, in the assembled configuration and as shown in FIG. 1, is positioned perpendicularly and operably coupled to the first slat 110 and the second slat 116. According to various embodiments of the present disclosure, the third slat 122 may interchangeably be referred to as the bumper portion or the extended bumper unless otherwise noted. The third slat 122 may be assembled to the first slat 110 and the second slat 116 using a first mating feature 124 and a second mating feature 126. The first mating feature 124 and the second mating feature 126 may be pin lock brackets, according to at least some embodiments. The first mating featuring 124 and the second mating feature 126 may be similar to the first mounting bracket 112 and the second mounting bracket 118 in some embodiments. The first slat 110 and the second slat 116 may be inserted into the first mating feature 124 and the second mating feature 126, respectively, and a pin or other mechanism known in the art may be used to secure the first slat 110 within the first mating feature 124 and the second slat within the second mating feature 126. For example, the first slat 110 is slidable within the first mounting bracket 112 and the first mating feature 124, and the second slat 116 is slidable within the second mounting bracket 118 and the second mating feature 126. In various embodiments, pins, screws, bolts, carabiners, locks, adhesives, chains, or any combination thereof may be used with the first mating feature 124 and the second mating feature 126 to secure the first slat and the second slat. In some embodiments, the first mating feature 124 and the second mating feature 126 are inserted within the first slat 110, and the second slat 116, respectively, and secured in a manner described above.

According to at least some embodiments, although the first slat 110, the second slat 116, and the third slat 122 are depicted as generally rectangular in cross section, the first slat 110, the second slat 116, and/or the third slat 122 may be tubular pipes or the like. For example, the cross section of the first slat 110, the second slat 116, and the third slat 122 may be any shape or configuration as would be appreciated by one having ordinary skill in the art upon reading the present disclosure.

According to various embodiments, the bumper extender 106 includes at least one strap 128 for wrapping around an overhanging article, such as article 101, on the vehicle 100. The at least one strap 128 operably couples a first end region 130 and a second end region 132 of the third slat 122. For example, the at least one strap 128 and the third slat 122 may include carabiners and/or loops for securing each end of the at least one strap 128 to the third slat 122. In some embodiments, the at least one strap 128 is removably coupled to the first end region 130 and the second end region 132 using one or more carabiners 133, as shown in FIG. 1. In an exemplary embodiment, the at least one strap 128 includes a tensioning device 134 located along the at least one strap 128 between the first end region 130 and the second end region 132 for adjusting an overall length of the at least one strap 128. The tensioning device 134 may be a ratchet or other tensioning device known in the art for forming a tight end strap (e.g., ratchet strap) such as the optional strap described above. In other embodiments, a rope, a wire, or other flexible material may be used to wrap around the article 101 and tension the bumper extender 106 with respect to the article 101, as would be appreciated by one having ordinary skill in the art upon reading the present disclosure.

As previously discussed, the bumper extender 106 does not bear weight according to some embodiments. Accordingly, the at least one strap 128 may be used to maintain the bumper extender 106 in a substantially parallel position relative to the ground. Furthermore, the at least one strap 128 may be used to minimize vibration of the bumper extender 106 as the vehicle 100 to which the bumper extender 106 is mounted travels along its route. In other embodiments, the bumper extender 106 or the bumper extender 106 in combination with the at least one strap 128 may be weight bearing if desired and as determined by the materials used for the bumper extender 106 as would be appreciated by one having ordinary skill in the art upon reading the present disclosure.

As described above, the bumper extender 106 may include a distal strap (not shown) and a second tensioning device (not shown) located along the distal strap. The distal strap tensions the distal end 114 of the first slat 110 and the distal end 120 of the second slat 116 in the assembled configuration.

In at least some embodiments, the bumper extender 106 includes one or more taillights 136 at least partially disposed within the third slat 122. The bumper extender 106 may further include wiring 138 at least partially disposed within the third slat 122 for providing power to the one or more taillights 136. The one or more taillights 136 may include turn signal lights and/or brake lights such that the bumper extender 106 is in compliance with various bumper and lighting safety requirements for vehicles as set by state law, federal law, or the like. The wiring 138 may be wired from the vehicle 100, through the first slat 110 and/or the second slat 116, in a manner known in the art for providing power and the appropriate signals to the lights for indicating turning, slowing down, and stopping of the vehicle 100, as appropriate. In one exemplary embodiment, the wiring 138 includes a four-pin electrical connector (not shown) that electrically couples the vehicle 100 to the bumper extender 106 (e.g., the taillights 136 of the bumper extender 106). According to at least some embodiments, the third slat 122 may further include one or more reflectors 140 disposed on the third slat 122. The bumper extender 106 may include any number of taillights, reflectors, etc., desired to replicate the form and function of the actual bumper of the vehicle 100.

According to at least one exemplary embodiment, bumper extender 106 extends beyond a distal end of the vehicle 100 (e.g., the distalmost edge 102 of the vehicle 100) less than or equal to 96 inches and a distal end 142 of the article 101 extends beyond the third slat 122 in the assembled configuration less than or equal to 10 inches.

In various embodiments, a length of the third slat 122 is less than or equal to a width of the vehicle 100. For example, the third slat 122 may span the entire width of the vehicle 100 or the third slat 122 may be less than the width of the vehicle 100.

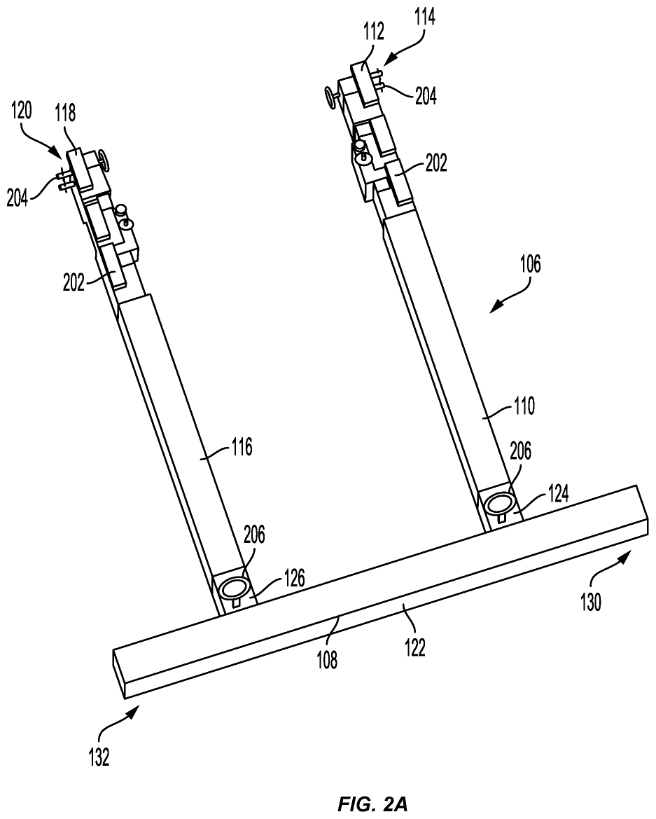

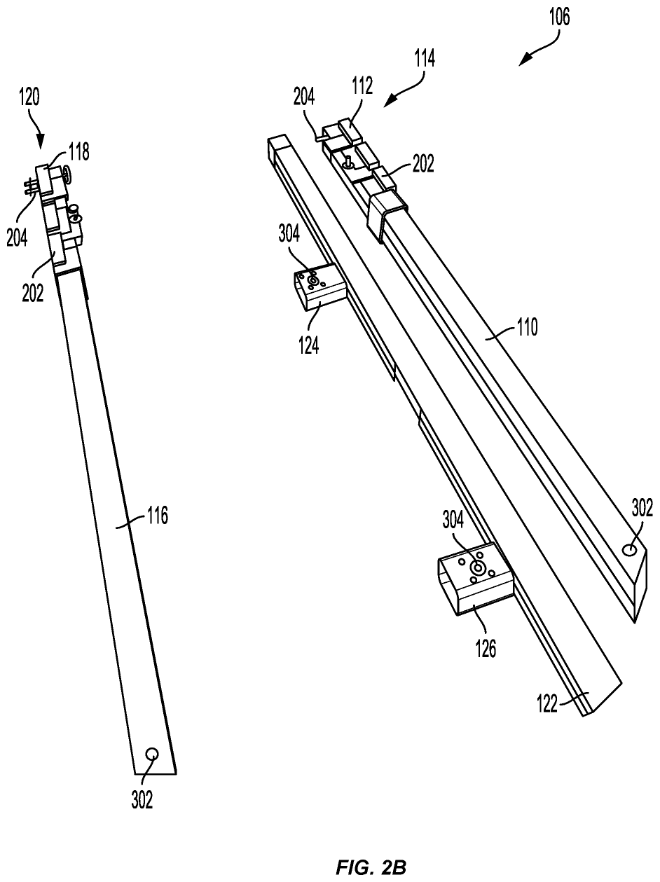

FIG. 2A illustrates an assembled removable extender. The description of the removable extender described with respect to FIG. 1 is applicable to the description of FIGS. 2A-2B and similar components may be indicated by similar numbering and have similar form and function unless otherwise noted. As shown in FIG. 2A, the bumper extender 106 is removed from a vehicle but otherwise assembled as would be appreciated by one having ordinary skill in the art upon reading the present disclosure. As shown in more detail, each of the first mounting bracket 112 and the second mounting bracket 118 includes a sliding rail 202 that slides along a corresponding rail on the vehicle. The sliding rail 202 may include one or more sections along the length of the first mounting bracket 112 and/or the second mounting bracket 118 depending on the stiffness and/or various weight requirements. For example, a vehicle may include existing rails as part of the design and the first mounting bracket 112 and the second mounting bracket 118 each include a sliding rail 202 for securing the first slat 110 and the second slat 116 to the vehicle. In various embodiments and as shown in FIG. 2A, the first mounting bracket 112 and the second mounting bracket 118 may each include a pin 204 for pin locking the first mounting bracket 112 and the second mounting bracket 118 to the vehicle. In some embodiments, the first mounting bracket 112 and the second mounting bracket 118 are slid along rails of the vehicle using a sliding rail 202 until pin holes corresponding to each pin 204 are aligned with corresponding pin holes on the vehicle. Each pin 204 may be used to further secure the first mounting bracket 112 and the second mounting bracket 118 to the vehicle.

According to an exemplary embodiment, a first mounting bracket 112 and a second mounting bracket 118 are operable to slide along and engage a first track and a second track of a vehicle, respectively. Each sliding rail 202 may be a linear rail and a first linear rail of the first mounting bracket 112 corresponds to the first track of the vehicle and a second linear rail of the second mounting bracket 118 corresponds to the second track of the vehicle.

In various embodiments, the first slat 110 and the second slat 116 are slidable within the first mounting bracket 112 and the second mounting bracket 118, respectively. In other embodiments, the first slat 110 and the second slat 116 are permanently or semi-permanently formed with the first mounting bracket 112 and the second mounting bracket 118, respectively.

Similarly, in various embodiments, the first slat 110 and the second slat 116 are slidable within the first mating feature 124 and the second mating feature 126, respectively. In other embodiments, the first slat 110 and the second slat 116 are permanently or semi-permanently formed with the first mating feature 124 and the second mating feature 126, respectively.

As further shown in FIG. 2A, the third slat 122 includes a first mating feature 124 and a second mating feature 126 for securing the first slat 110 and the second slat 116 to the third slat 122 in the assembled configuration. Each of the first mating feature 124 and the second mating feature 126 may include a pin loop 206. Each pin loop 206 may be part of a pin lock for securing the first slat 110 within the first mating feature 124 and the second slat 116 in the second mating feature 126 as would be appreciated by one having ordinary skill in the art. Alternatively, or in addition to, each pin loop 206 may be a loop for securing the at least one strap (not shown) that wraps around the overhanging article and is secured to the first end region 130 and the second end region of 132 of the third slat. For example, a carabiner clipped to each end of the at least one strap may be clipped to each pin loop 206 for securing and maintaining the position of the bumper extender 106 relative to the overhanging article, as described in detail above.

Accordingly, the at least one strap is removably coupled to the first end region 130 and the second end region 132 of the third slat 122.

FIG. 2B illustrates a disassembled removable extender. The description of the removable extender described with respect to FIG. 1 is applicable to the description of FIGS. 2A-2B and similar components may be indicated by similar numbering and have similar form and function unless otherwise noted. As shown in FIG. 2B, the bumper extender 106 may be disassembled for storage and transportation when not in use. For example, the bumper extender 106 may be an assembled structure of removably couplable slats (e.g., the first slat 110, the second slat 116, and the third slat 122). In other embodiments, the bumper extender 106 is an integrally formed frame and is removed as illustrated in FIG. 2A and is not further disassembled. Visible in this view, the first slat 110 and the second slat 116 may each include a pin hole 302. Each pin hole 302 may be aligned with a corresponding pin hole 304 located on each of the first mating feature 124 and the second mating feature 126 of the third slat 122. As would be appreciated by one having ordinary skill in the art upon reading the present disclosure, a pin locking mechanism, such as pin loop 206 shown in FIG. 2A, may be used to lock the first slat 110 within the first mating feature 124 and the second slat 116 within the second mating feature 126

Advantageously, the first slat 110, the second slat 116, and the third slat 122 may be disassembled for reducing an overall footprint of the bumper extender 106 during storage and/or transportation. For example, an operator may transport the bumper extender 106 in a disassembled configuration within the vehicle or otherwise secured to the vehicle (e.g., on a trailer or the like). Once the operator and the vehicle reach the destination having the article to be transported, the bumper extender 106 may be mounted to the vehicle for extending the bumper of the vehicle such that the article does not overhang the extended distalmost edge of the vehicle (e.g., now, the distalmost edge of the mounted bumper extender 106) by a predetermined amount. Accordingly, the bumper extender 106 may be efficiently stored between uses until use of the bumper extender 106 is needed (e.g., to avoid a permitting process or the like) or otherwise desired by an operator.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A removable extender for a vehicle, comprising:
a first slat having a first mounting bracket disposed at a distal end;
a second slat having a second mounting bracket disposed at a distal end, the second slat spaced apart and substantially parallel to the first slat, in an assembled configuration;
a third slat, in the assembled configuration, positioned perpendicularly to the first slat and the second slat, wherein the third slat is assembled to the first slat and the second slat using a first mating feature and a second mating feature;
at least one strap for wrapping around an overhanging article on a vehicle, the at least one strap operably coupling a first end region and a second end region of the third slat; and
a tensioning device located along the at least one strap between the first end region and the second end region for adjusting an overall length of the at least one strap.

2. The removable extender of claim 1, further comprising: a distal strap; and a second tensioning device located along the distal strap, wherein the distal strap tensions the distal end of the first slat and the distal end of the second slat in the assembled configuration.

3. The removable extender of claim 1, wherein the first mounting bracket and the second mounting bracket are operable to secure the first slat and the second slat to the vehicle.

4. The removable extender of claim 1, further comprising: one or more taillights at least partially disposed within the third slat; and wiring for providing power to the one or more taillights.

5. The removable extender of claim 4, wherein the wiring includes a four-pin electrical connector.

6. The removable extender of claim 1, wherein the first mounting bracket and the second mounting bracket are pin lock brackets.

7. The removable extender of claim 1, further comprising: one or more reflectors disposed on the third slat.

8. The removable extender of claim 1, wherein the removable extender extends beyond a distal end of the vehicle less than or equal to 96 inches.

9. The removable extender of claim 1, wherein a distal end of the overhanging article extends beyond the third slat in the assembled configuration less than or equal to 10 inches.

10. The removable extender of claim 1, wherein a length of the third slat is less than or equal to a width of the vehicle.

11. The removable extender of claim 1, wherein the at least one strap is removably coupled to the first end region and the second end region using one or more carabiners.

12. The removable extender of claim 1, wherein the first slat is slidable within the first mounting bracket and the first mating feature, and the second slat is slidable within the second mounting bracket and the second mating feature.

13. The removable extender of claim 1, wherein the first slat is integrally formed with the first mounting bracket and the second slat is integrally formed with the second mounting bracket.

14. A removable extender for a vehicle, comprising:
an extension component comprising:
a first mounting bracket operable to slide along and engage a first track of a vehicle;
a second mounting bracket operable to along and engage a second track of the vehicle, and;
a bumper portion comprising a first end region and a second end region; and
at least one strap for wrapping around an overhanging article on the vehicle, the at least one strap operably coupling the first end region and the second end region of the bumper portion.

15. The removable extender of claim 14, wherein the first mounting bracket includes a first linear rail corresponding to the first track and the second mounting bracket includes a second linear rail corresponding to the second track.

16. The removable extender of claim 14, wherein the extension component is an integrally formed frame.

17. The removable extender of claim 14, wherein the extension component is an assembled structure of removably couplable slats.

18. The removable extender of claim 14, wherein the first mounting bracket and the second mounting bracket are pin lock brackets.

19. The removable extender of claim 14, further comprising: one or more taillights at least partially disposed within the bumper portion; and wiring for providing power to the one or more taillights.

20. The removable extender of claim 14, further comprising: a tensioning device located along the at least one strap between the first end region and the second end region for adjusting an overall length of the at least one strap.
